(19) United States
(12) Patent Application Publication
(10) Pub. No.: US 2002/0045689 A1
(43) Pub. Date: Apr. 18, 2002

(54) Photochromic resins and articles; preparation; precursor compositions.

(76) Inventors: David Henry, Morigny-Champigny (FR); Cecile Lecrivain, Fontenay-sous-Bois (FR)

Correspondence Address: CORNING INCORPORATED, SP-TI-3-1, CORNING, NY, 14831

(21) Appl. No.: 09/907,080

(22) Filed: Jul. 17, 2001

(30) Foreign Application Priority Data
Jul. 17, 2000 (FR) 00 09340

(51) Int. Cl. C08K 5/53; C08K 5/41

(52) U.S. Cl. 524/130; 524/155

(57) ABSTRACT

Disclosed are photochromic resins having improved photochromic properties; articles, notably ophthalmic articles, which are constituted, wholly or in part only, of such resins; radically polymerizable compositions which are precursors of said resins; and methods of preparing said resins. Said resins are obtained by radical copolymerization of particular comonomers. They contain an effective amount of at least one acidic additive or of at least one basic additive, and they have improved kinetics of return to the light state.

The aim of the present invention is:

photochromic resins having improved photochromic properties;

articles, notably ophthalmic articles, which are constituted, wholly or in part only, of such resins;

radically polymerisable compositions, which are precursors of said resins; and

a method of preparing said resins.

The manufacture of a plastic ophthalmic lens is a difficult exercise insofar as it is required that the structure of said lens be free from optical constraints and obviously possesses satisfactory mechanical properties. In order to attain this result, it is necessary to perfectly master the copolymerisation reactions implemented during the preparation of said lens. It is necessary in any case to avoid attaining the gel point of the reaction system too rapidly since, in the hypothesis of “local over-cross-linking”, strings and other optical faults inexorably appear. This problem is a real problem insofar as the basic monomers known hitherto are generally symmetrical difunctional monomers.

Furthermore, within the context of the manufacture of photochromic ophthalmic lenses, either by radical polymerisation of compositions which contain at least one photochromic colorant, or by later diffusion of such colorants within the polymerised matrices, it is necessary that the structure of said lens possesses, in addition to the optical qualities set forth supra, a pronounced aptitude to favour the expression of the photochromic properties of said colorants which intervene; and this without notably altering its mechanical properties.

Obtaining an acceptable compromise—optical properties, even photochromic/mechanical properties—is not an easy thing.

Hitherto, the Applicant and his competitors are still working on the improvement of this compromise.

Numerous pieces of work have, in recent years, concerned the nature of the matrix.

Photochromic transparent organic materials which have good photochromic properties are described in U.S. Pat. No. 5,973,039. They are based on a tetraethoxylated bisphenol A dimethacrylate homopolymer and contain suitable photochromic colorants. The polymerisation is carried out in the presence of a suitable radical polymerisation initiator. The optical quality of these materials does however reveal to be insufficient for ophthalmic applications.

U.S. Pat. No. 5,349,035 proposes, in order to minimise, even prevent optical constraints, to combine at least one other monomer, notably styrene, with a dimethacrylate type monomer (and notably with that set forth supra), and to carry out the copolymerisation in the presence of an effective amount of a chain transfer agent. The matrix obtained is however not suitable for expressing the photochromic properties of photochromic colorants. Said matrix notably has fading kinetics which are much too slow.

Furthermore, in the application WO-A-98 50443, organic materials have been described which are photochromic or not, which are improved, and which are based on at least two different types of difunctional monomers.

In U.S. Pat. No. 3,627,690, the beneficial incorporation is very generally described of a base or of an acid, weak to moderate, into photochromic compositions which contain naphthopyrans as photochromes. Said incorporation was described as beneficial with regard to the kinetics of return to the light state, both within solutions as well as within resins, notably of the polymethylmethacrylate or polystyrene type. However, every example describes solutions and the inventors of the present invention have established that said beneficial effect only expressed itself within certain types of resin.

Within the context of the present invention, a beneficial effect has been demonstrated, with regard to the photochromic properties, more particularly with regard to the kinetics of return to the light state, of the presence within very particular resins, of at least one acid or of at least one base. Characteristically, said resins are obtained from at least one monomer which can generate, by homopolymerisation, a rigid structure, and from at least one monomer which can generate, by homopolymerisation, a flexible structure.

According to a first aspect, the present invention relates to photochromic resins which are obtainable by radical copolymerisation of a composition of specific monomers; and

which characteristically contain, together, an effective amount of at least one photochromic colorant and an effective amount of at least one acidic additive or of at least one basic additive.

More specifically, the present invention relates to photochromic resins which are obtainable by radical copolymerisation of a composition which contains:

at least one difunctional monomer, selected from those of formula (I) and (II) below:

formula (I):

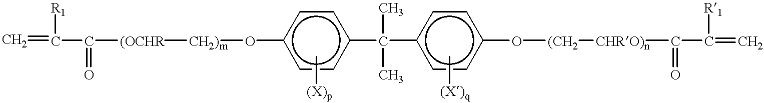

in which:

R₁, R′₁, R and R′, which are identical or different, independently are a hydrogen or a methyl group;

m and n are, independently, integers between 0 and 4 inclusive; and advantageously are independently equal to 1 or 2;

X and X′, which are identical or different, are a halogen and preferably represent a chlorine and/or a bromine;

p and q are, independently, integers between 0 and 4 inclusive;

formula (II):

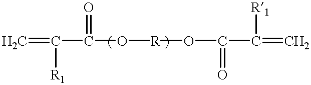

in which:

R₁ and R′₁, which are identical or different, independently are a hydrogen or a methyl group;

R is a linear or branched alkylene radical having 2 to 8 carbon atoms, a cycloalkylene radical having 3 to 6 carbon atoms, an ether radical of formula (R′—O—R″) in which R′ and R″, which are identical or different, independently are a linear or branched alkylene radical having 2 to 4 carbon atoms;

at least one other monomer, selected from the monofunctional monomers of formula (III) below and the alkenic difunctional monomers of formula (IV) below:

formula (III):

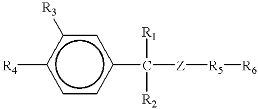

in which:

R₁ and R₂, which are identical or different, independently are hydrogen or an alkyl radical, which is linear or branched, advantageously linear, having 1 to 4 carbon atoms; and particularly advantageously correspond to a methyl group;

R₃ and R₄, which are different, independently are one hydrogen and the other an alkenyl radical having 2 to 6 carbon atoms, advantageously 2 to 4 carbon atoms, and particularly advantageously an isopropenyl radical;

Z represents a carbamate function (—NH—CO—O—), a thiocarbamate function (—NH—CO—S—), a urea function (—NH—CO—NR₇, with R₇ which represents hydrogen or a linear, branched or cyclic alkyl group having 1 to 6 carbon atoms) or an oxazolidone function

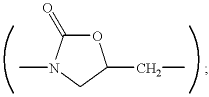

R₅ is selected from the group comprising:

the alkylene oxide radicals and the polyalkylene oxide chains of formula:

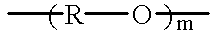

in which the R groups, which are identical or different when m≧2, are alkylene radicals, which are linear or branched and which have 2 to 5 carbon atoms and m is an integer, such that the total number of carbon atoms of said alkylene oxide radicals and polyalkylene oxide chains be between 2 and 112;

the ester radicals and the polyester chains of formula:

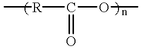

in which the R groups, which are identical or different when n≧2, are alkylene radicals which are linear or branched and which have 2 to 5 carbon atoms and n is an integer, such that the total number of carbon atoms of said ester radicals and polyester chains be between 2 and 168;

the siloxane radicals and the polysiloxane chains of formula:

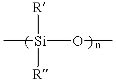

in which the R′ and R″ groups, which are identical or different when n≧2, are, independently, alkyl radicals having 1 or 2 carbon atoms and n is an integer between 1 and 18;

the carbonate radicals and the polycarbonate chains of formula:

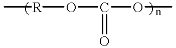

in which the R groups, which are identical or different when n≧2, are alkylene radicals, which are linear or branched and which have 1 to 5 carbon atoms and n is an integer between 1 and 21;

R₆ is an alkyl radical or an aryl radical;

formula (IV):

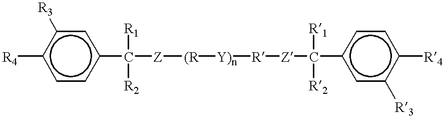

in which:

R₁, R′₁, R₂ and R′₂, which are identical or different, independently are hydrogen or an alkyl radical, which is linear or branched, advantageously linear, and which has 1 to 4 carbon atoms; and particularly advantageously correspond to a methyl group;

R₃ and R₄, which are different, independently are one hydrogen and the other an alkenyl radical having 2 to 6 carbon atoms, advantageously 2 to 4 carbon atoms, and particularly advantageously an isopropenyl radical;

R′₃ and R′₄, which are different, independently are one hydrogen and the other an alkenyl radical having 2 to 6 carbon atoms, advantageously 2 to 4 carbon atoms, and particularly advantageously an isopropenyl radical; with advantageously R₃=R′₃ and R₄=R′₄;

Z represents a carbamate function (—NH—CO—O—), a thiocarbamate function (—NH—CO—S—), a urea function (—NH—CO—NH—) or an oxazolidone function

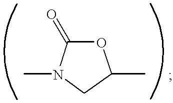

Z′, independently of Z and advantageously with respect to Z, represents a carbamate function (—O—CO—NH—), a thiocarbamate function (—S—CO—NH—), a urea function (—NH—CO—NH—) or an oxazolidone function

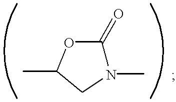

R′ represents a linear or branched alkylene radical having 2 to 4 carbon atoms;

R, which is identical or different when n≧2, is a linear or branched alkylene radical having 2 to 4 carbon atoms;

Y, which is identical or different when n≧2, is oxygen or sulphur;

n is an integer defined such that the total number of carbon atoms, contained in the long chain situated between the two Z and Z′ units, be at least equal to 18 and advantageously be between 18 and 112 inclusive;

said resins of the invention also containing:

an effective amount of at least one photochromic colorant, conferring photochromic properties to them; as well as

an effective amount of at least one acidic additive or of at least one basic additive; said amount, which is effective for improving the kinetics of return to the light state of said resins, representing at the most 5% of the weight of the polymerisable monomers of the composition; said effective amount advantageously representing between 0.01 and 3% of the weight of said monomers.

Said photochromic colorant(s) and acid(s) or base(s) are incorporated more or less upstream in the process of preparing the resin. They are added into the composition of monomers (to be polymerised) and/or are allowed to diffuse within the resin (polymerised composition), and they are found in any case in the final resin.

It is proposed below to give several specifications on the monomers of formulae (I), (II), (III) and (IV), on several other monomers and compounds which can be incorporated into the basic compositions, i.e. the precursors of the resins of the invention, on the photochromic colorants which can be incorporated, before developing the key of the present invention: the incorporation of at least one acid or of at least one base, with reference to the improvement of the kinetics of return to the light state.

The difunctional monomers of formula (I) and (II) are monomers which are able to generate, by homopolymerisation, a rigid structure, while the monomers of formula (III) and (IV) are monomers which are able to generate, by homopolymerisation, a flexible structure.

The monomers of formula (I), (II) and (IV) are perfectly described in the literature, notably their combination, in the patent application WO-A-98 50443.

The monomers of formula (III) have been described more recently in the French application FR-A-00 06988, hitherto unpublished.

The following is specified or recalled with reference to said monomers of formulae (I), (II), (III) or (IV).

The monomers of formula (I) and (II) are difunctional monomers, diacrylates, dimethacrylates, even mixed acrylate and dimethacrylate monomers (reference is made in this regard to the values of R₁ and R′₁ in said formulae (I) and (II)).

Said difunctional monomers which are incorporated in the compositions of the invention may or may not all be of the same formula (I) or (II). Thus, the polymerisable compositions of the invention can contain:

either difunctional monomers of a same formula (I);

or difunctional monomers of a same formula (II);

or mixtures (non-mixed) of different monomers of formula (I) or (II);

or mixtures (mixed) of monomers of formula(e) (I) and formula(e) (II).

According to a preferred variant of the invention, one or more symmetrical difunctional monomers of formula (I) are used.

Monomers of formula (I) or (II) are qualified as symmetrical, when R₁ and R′₁ groups are identical, the same applies for the R and R′ groups, and the substituents X and X′ for the compounds of formula (I).

Said symmetrical monomers of formula (I) are known and are available commercially or are easily accessible to the person skilled in the art. In fact, it may be noted that said monomers which do not possess a halogen on the aromatic rings correspond to the first monomers of formula (I) in the sense of document WO-A-92 05209. Said monomers of formula (I) having halogen(s) on the aromatic ring(s) are obtained easily by the person skilled in the art by using derivatives which are suitably substituted on said aromatic ring(s). Within the context of the invention, the monomers of formula (I), in which R and R′, which are identical, are hydrogen or a methyl group, R₁ and R′₁ are a methyl group, m and n are independently equal to 1 or 2, and p=q=0, are preferred. A particularly advantageous variant corresponds to the monomer of formula (I) of the type above with, further R=R′=H and m=n=2. Said monomer is marketed notably by the company AKZO NOBEL (NL) under the commercial denomination DIACRYL 121.

The synthesis of the asymmetrical monomers of formula (I) does not present any particular problem to the person skilled in the art.

The monomers of formula (II) are also well known and result from the classical reaction of an aliphatic diol and a short chain alkylene glycol (with a maximum of 8 carbon atoms in said chain) with at least one type of (meth)acrylic derivative depending on whether it is desired to obtain monomers of formula (II) which are symmetrical or asymmetrical at their ends.

The resins of the invention are advantageously obtained by radical copolymerisation of a composition which contains at least one monomer of formula (I).

The monomers of formula (III) are monofunctional monomers the incorporation of which is particularly recommended as monomer precursors of the resins of the invention. They can improve the copolymerisation in question and can confer, as indicated supra, flexibility to the resulting copolymer.

The following is specified with regard to substituents R₃, R₄, R₅ and R₆ of said formula (III).

R₃ or R₄, alkenyl radical, advantageously isopropenyl radical, constitutes the functional group of the (monofunctional) monomers of formula (III). In formula (III), R₃ advantageously represents an isopropenyl radical (while R₄ represents hydrogen).

R₅ constitutes the group which can confer flexibility to the final copolymer. R₆ is the terminal group of the chain. The nature of said terminal group is not a determining factor. It is advantageously a linear, cyclic or branched alkyl group which comprises 1 to 9 carbon atoms (preferably 1 to 4 carbon atoms) or an aryl group selected from optionally substituted phenyl and naphthyl groups. In formula (III), R₅ advantageously represents an alkylene oxide radical or a polyalkylene oxide chain. Particularly preferably, R₅ is selected from:

an ethylene oxide radical,

a polyethylene oxide chain,

a propylene oxide radical,

a polypropylene oxide chain,

a tetramethylene oxide radical, and

a polytetramethylene oxide chain.

It will obviously have been understood that for R₅, “radical” is referred to when m or n=1 and “chain” is referred to when m and n>1.

The monomers of formula (III) can be obtained without any particular difficulty by condensation of an isocyanate function-bearing unsaturated compound such as 3-isopropenyl-α,α-dimethylbenzylisocyanate (notably marketed under the reference m-TMI® by the company CYTEC) and of an amine-, hydroxyl-, thiol-, or epoxy-bearing compound which contains a flexible group (R₅). The reagents in question are:

firstly:

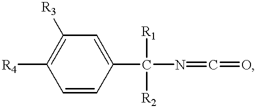

and secondly:

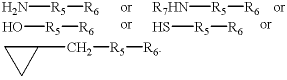

The resins of the invention are advantageously obtained by radical copolymerisation of a composition which contains at least one monomer of formula (III) in which R₃ is an isopropenyl radical and R₅ represents an alkylene oxide radical or polyalkylene oxide of formula

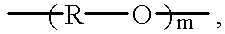

as defined supra.

The monomers of formula (IV) are difunctional monomers having a long chain. They correspond to the difunctional monomers of type (b), of formula (B), (B′) and (B″) of the document WO-A-98 50443. For more information thereon, the teaching of document WO-A-98 50443 will be referred to.

The monomers of formula (IV), which can be used in the preparation of the resins of the invention, advantageously are of formula (IV) in which R₃ and R′₃ are isopropenyl radicals, while Y is oxygen and Z and Z′ represent urea functions.

Other monomers, and notably:

at least one aromatic monovinylic monomer of formula (C):

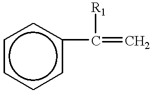

in which R₁=H or CH₃;

and/or

at least one aromatic divinylic monomer of formula (D):

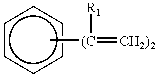

in which R₁=H or CH₃;

and/or

at least one (meth)acrylic monomer of formula (E):

CH₂═C(R)—COOR′

in which R=H or CH₃ and R′ is a linear or branched alkyl radical having from 1 to 16 carbon atoms, an optionally substituted benzyl or phenoxy(C₁-C₄)alkyl radical or a polyoxyethylene group of formula —(CH₂—CH₂—O)ₙR″ in which n is an integer between 1 and 10 and R″=CH₃ or C₂H₅;

and/or

diallylphthalate,

and/or

at least one acrylic monomer having at least three reactive functions, advantageously selected from:

pentaerythritol triacrylate,

pentaerythritol tetraacrylate,

propoxylated glycerol triacrylate,

trimethylolpropane triacrylate,

polyurethane triacrylate,

dipentaerythritol hexaacrylate,

and preferably consisting of pentaerythritol triacrylate,

can be found in a mixture with said monomers of formula [(I) and/or (II)+(III) and/or (IV)] in the polymerisable compositions, i.e. precursors of the resins of the invention.

The vinylic monomers of formula (C)—styrene and/or methylstyrene—are advantageously incorporated in order to lower the viscosity of the mixtures of comonomers, to reduce the density of cross-linking of the resin, and to adjust the refractive index of it.

The compounds of formula (D) consist of divinylbenzene (DVB) and di(isopropenyl)benzene. The incorporation of at least one compound of formula (D) can reveal to be advantageous notably in that said compound in general tempers the effects of the compound(s) of formula (C). The beneficial effect of such a compound of formula (D) has been notably demonstrated upon the expression of photochromic properties. In reference to divinylbenzene, insofar as this polymerised compound has a relatively high refractive index (n=1.61), its incorporation is equally beneficial in that it brings about an increase in the refractive index of the resins of the invention.

The polymerisable composition, i.e. the precursor of the resins of the invention, advantageously also contains at least one compound of formula (E). This is a (meth)acrylic monomer as defined above. Notably, it can be butyl, pentyl, hexyl, heptyl, octyl, 2-ethylhexyl, benzyl or phenoxyalkyl (meth)acrylate, or even ethyl triglycol(meth)acrylate. The presence of this type of compound can reveal to be advantageous for adjusting the viscosity of the mixture of comonomers, the density of cross-linking of the resin, the refractive index of said resin, for the turning out (from the mould) of said resin and for the implementation of finishing treatments of the latter.

The polymerisable composition can also contain diallylphthalate which notably enables the index and/or other optical and mechanical properties to be adjusted.

Finally, the polymerisable composition can advantageously further contain at least one acrylic monomer which has at least three reactive functions (which generally has 3, 4, 5 or 6 reactive functions). Such a monomer is incorporated as a monomer which constitutes the final matrix, but above all as a copolymerisation accelerator. Advantageously, it is selected from:

pentaerythritol triacrylate,

pentaerythritol tetraacrylate,

propoxylated glycerol triacrylate,

trimethylolpropane triacrylate,

polyurethane triacrylate,

dipentaerythritol hexaacrylate,

and preferably consists of pentaerythritol triacrylate.

Its incorporation, in substitution, at least partial, of a difunctional acrylic monomer or in addition to a suitable mixture of monomers improves the polymerisation kinetics, without inducing a fault in the final product.

Generally, said acrylic monomer(s), which is or are at least trifunctional and which is or are polymerisation accelerators, is or are incorporated at the rate of 2 to 10%, advantageously 4 to 6% by weight, with respect to the total weight of the mixture of monomers to be copolymerised.

As specified above, the incorporation of compounds of formula (C) and/or (D) and/or (E) and/or of diallylphthalate and/or of at least one acrylic monomer which is functionalised at least three times is not mandatory. The incorporation does however reveal to be generally advantageous.

The polymerisable compositions of the invention, i.e. the precursors of the resins of the invention, generally contain an effective amount of at least one radical polymerisation initiator, in addition to all the above compounds.

Said intervening radical polymerisation initiator(s) may be thermal or photochemical. Depending on the way the polymerisation—thermal polymerisation and/or photochemical polymerisation—is carried out, a single type of initiator (thermal or photochemical) is used or two types of initiators (thermal and photochemical) are used together.

Said intervening radical polymerisation initiator(s) must be “inert” towards the present photochromic colorant(s).

If a thermal polymerisation is carried out, the intervening radical polymerisation initiator(s) is (are) advantageously selected from the diazo compounds. These compounds are familiar to the person skilled in the art and are commercially available. Examples of such diazo compounds are 2,2′-azobisisobutyronitrile (AIBN), 2,2′-azobis(2-methylbutyronitrile)(AMBN) and 2,2′-azobis(2,4-dimethylpentanenitrile) (ADVN).

The thermal radical polymerisation initiator(s) is(are) used in an effective quantity, generally at a rate of 0.01 to 1% by weight, preferably from 0.05 to 0.5% by weight, with respect to the weight of the monomers present. In the absence of such an initiator or in the presence of too low an amount of it, it becomes necessary to carry out the copolymerisation at a higher temperature and this renders the reaction difficult to control. In the presence of too great an amount of such an initiator, an excess of free radicals may be generated, this excess of free radicals inducing a destruction of the photochromic colorant(s) present and an accelerated fatigue of the final material. In this latter hypothesis, the reaction carried out may also accelerate and become difficult to control.

If a photochemical polymerisation is carried out, the intervening radical polymerisation initiator(s) is(are) especially selected from the acyl oxides and diacyl phosphine oxides. The said initiator advantageously consists in a diacyl phosphine oxide.

In such a context, the intervening photochemical radical polymerisation initiator(s) and the present photochromic colorant(s) are generally competitors with regard to the UV consumption. Due to the said competition, the said photochemical radical plymerisation initiator(s) is(are) generally used in a limited quantity—less than or equal to 0.009 parts by weight per 100 parts by weight of the mixture of monomers to copolymerise (advantageously between 0.002 and 0.009 parts by weight)—in combination with at least one thermal radical polymerisation initiator. A thermal and photochemical polymerisation is then carried out.

It is however not totally excluded to use greater amounts of photochemical initiator(s) (generally at a rate inferior or equal to 2% by weight with respect to the weight of the monomers present) in contexts in which the above-explained competition is minimized, even cancelled, due to the specific nature of the used colorant(s) and initiator(s). In such contexts, the carried out radical polymerisation may be a pure photochemical one.

The man skilled in the art is able to determine and optimise the used amounts of radical polymerisation (thermal and/or photochemical) initiator(s).

In certain contexts, it can reveal to be advantageous, even indispensable, to further incorporate, within the polymerisable compositions of the invention, an effective amount (generally less than 5% by weight, in principle 0.01 to 2% by weight, with respect to the weight of monomers present) of at least one polymerisation modifier.

Obviously, it is necessary that said polymerisation modifier does not destroy the photochromic colorant(s) present during the polymerisation and/or does not induce a discoloration of the material on its own. Said polymerisation modifier can be a non-halogenated chain transfer agent such as a linear alkane thiol or bis-mercapto-ethyl ether. Dodecane thiol may be cited as an example of a linear alkane thiol without being limiting. It is not excluded to use other types of chain transfer agents such as alkane thiols substituted with at least one aryl or alkyl radical, or thiophenols. All these compounds are familiar to the person skilled in the art and are commercially available.

The resins of the invention are thus obtained by radical copolymerisation, which is generally carried out in the presence of a copolymerisation auxiliary (see the polymerisation initiators and modifiers described supra), of a mixture of monomers as specified supra. They are photochromic resins. They therefore contain within them an effective amount of at least one photochromic colorant. Classically, said colorant(s) can be incorporated before and/or after the copolymerisation.

Said colorant(s) is(are) advantageously selected from the group of spiroxazines, spiropyrans, chromenes, fulgides, fulgimides and mixtures thereof.

Very numerous photochromic colorants of the above type are described in the literature and are available on the market.

Spiroxazine colorants which may be used within the context of the present invention have notably been described in the U.S. Pat. Nos. 3,562,172, 4,634,767, 4,637,968, 4,720,547, 4,756,973, 4,785,097, 4,792,224, 4,816,584, 4,831,142, 4,909,963, 4,931,219, 4,936,995, 4,986,934, 5,114,621, 5,139,707, 5,233,038, 4,215,010, 4,342,668, 4,699,473, 4,851,530, 4,913,544, 5,171,636, 5,180,524, 5,166,345, in the patent applications EP-A-0 508 219, 0 232 295 and 0 171 909 and in the application FR-A-2,738,248.

Chromene colorants which are usable within the context of the present invention are notably described in U.S. Pat. Nos. 3,567,605, 4,889,413, 4,931,221, 4,980,089, 5,066,818, 5,106,998, 5,130,058, 5,200,116, 5,224,602, 5,238,981, 5,973,039, and the application EP-A-0 562 915. Said chromenes may notably consist of naphthopyrans.

Spiropyran colorants which are also usable within the context of the present invention are notably described in the following texts:

PHOTOCHROMISM G. Brown, Editor—Techniques of Chemistry—Wiley Interscience—Vol. III—1971—Chapter III—Pages 45-294—R. C. Bertelson.

PHOTOCHROMISM—Molecules & Systems—Edited by H. Dürr—H. Bouas-Laurent—Elsevier 1990—Chapter 8: Spiropyrans—Pages 314-455—R. Gugliemetti.

The incorporation of chromenes is largely preferred within the context of the present invention. It is with said chromenes that the beneficial action of the acidic additives or basic additives is exacerbated.

It has been indicated that the resins of the invention contain an effective amount of at least one photochromic colorant. It is in fact frequent, within the context of the present invention, to incorporate a combination of photochromic colorants, with the aim of obtaining a specific tint in the darkened state.

By way of reference and in no way limiting, it is indicated at this juncture that said photochromic colorants are generally incorporated in the compositions to be polymerised and polymerised resins of the invention at a rate of 0.01 to 1% by weight, advantageously at a rate of 0.05 to 0.5% by weight with respect to the total weight of monomers.

Said photochromic colorants may themselves very well contain a polymerisable and/or cross-linkable reactive group in their chemical formula as well. They are incorporated themselves, if they are incorporated before the copolymerisation, as co-monomers in the composition to be polymerised, and thus they are chemically bound, i.e. grafted, to the matrix of said polymerised composition. Generally, the resins of the invention contain their photochromic colorant(s) free or bound to their matrix.

The key of the present invention is now approached: the additives, acidic or basic, which, within the rigid/flexible matrix of the invention, improve the kinetics of return to the light state.

Said additives, which are acidic or basic, are copolymerisable or non-copolymerisable chemical compounds. They may themselves be incorporated before and/or after the copolymerisation. If they are copolymerisable chemical compounds, they are advantageously incorporated beforehand, such that they are perfectly stabilised in the matrix of the resin.

Said additives, which are acidic or basic, are incorporated in an effective amount which, very generally, is less than 5% by weight of the weight of the monomers constituting the resin. Said effective amount is generally situated between 0.01 and 3% by weight of the weight of said monomers.

In any case, said effective amount is obviously a function of the strength of the acid or the base in question (acids or bases in question if several of them are incorporated together).

Thus, for the acids: those having the strongest acidity (a dissociation constant: k>10⁻²) are generally used in amounts of less than 1% by weight, preferably in amounts neighbouring 0.1% by weight;

those having weaker acidities (a dissociation constant: k<10⁻²) are generally used in amounts of greater than or equal to 1% by weight.

The preferred acidic additives—which are copolymerisable or non-copolymerisable—have, in any case, a dissociation constant: k>10₋₆.

Said acidic additives are advantageously selected from:

organic sulphonic acids;

organic phosphorus-containing acid compounds; and

organic carboxylic acids; said carboxylic acids being particularly preferred.

It is now proposed to expressly specify, in a totally non-limiting manner, the nature of some of said acids which are suitable for the aims of the invention.

Amongst the sulphonic acids:

para-toluenesulphonic acid,

naphthalenesulphonic acids,

sulphosalicylic acids,

hydroxybenzenesulphonic acids, and

dodecylbenzenesulphonic acids

may be expressly cited.

Amongst the phosphorus-containing compounds:

diphenylphosphoric acid,

diphenylphosphinic acid,

bis(p-methoxyphenyl)phosphinic acid,

alkylphosphoric acids, and

alkylphosphonic acids

may be expressly cited.

The Encylopaedia of Chemical Technology, Kirk-Othmer, second edition, Volume 1, pp. 224 to 254, can be referred to for carboxylic acids, which are particularly preferred, of general formula R—COOH.

Said carboxylic acids are, generally, classified as aliphatic, alicyclic, aromatic and heterocyclic carboxylic acids.

They are mono- or plurifunctional (monocarboxylic, dicarboxylic, tricarboxylic . . . ), substituted or non-substituted, saturated or unsaturated.

It is proposed to cite a few of them below, in a totally non-limiting manner, which are particularly suitable for the aims of the invention.

Amongst the aliphatic carboxylic acids,

aliphatic monocarboxylic acids: formic, acetic, propionic, butyric, isobutyric acids, chloroacetic acids, glycolic and cyclohexanecarboxylic acids can be cited in a non-exhaustive manner. As for these, reference can be made to the first part of Table 1, page 226, of the bibliographic reference given above;

aliphatic di- and tricarboxylic acids: oxalic, malonic, succinic, fumaric, maleic and malic acids can be cited in a non-exhaustive manner. As for these, reference can be made to the second part of said Table;

acrylic and methacrylic acids, crotonic acids, propiolic, itaconic, maleic, fumaric, aconitic acids and mono-2-(methacryloxy)ethyl succinate can also be cited. Given the corrosive and volatile aspect, combined with a strong odour, of the acids of low molecular mass (C₁-C₄), the above acids having C₃ and more are a priori preferred.

Amongst said aliphatic carboxylic acids, those which can be copolymerised with the resin, and notably acrylic, methacrylic and maleic acids, are more particularly preferred in the sense of the invention.

Amongst the aromatic carboxylic acids,

aromatic monocarboxylic acids: benzoic acid, o-, m-, p-toluic acids, naphthoic acids, salicylic acids, phenylacetic, mandelic, chloro- and nitrobenzoic acids and veratric acids are cited in a non-exhaustive manner. Amongst said aromatic monocarboxylic acids, 3-methylsalicylic and 4-methylsalicylic are particularly preferred within the context of the present invention;

aromatic di- and tricarboxylic acids: o-phthalic, o-phenyldiacetic and tricarballylic acids, and mono-2-(methacryloxy)ethyl phthalate are cited in a non-exhaustive manner.

With reference to the basic additives, it has been seen that they are copolymerisable or non-copolymerisable. Advantageously, they are selected from:

acrylate or methacrylate monomers, which are bearers of at least one tertiary amine function; such as dimethylaminoethyl methacrylate and diethylaminoethyl methacrylate; and

triarylphosphines, advantageously triphenylphosphine.

The inventors have clearly demonstrated that within the resins based on monomers of formula [(I) and/or (II)+(II) and/or (IV)], the incorporation of said acidic or basic additives is very advantageous. They accelerate the return to the light state.

According to another of its objects, the invention relates to articles, notably ophthalmic articles, which are constituted, wholly or in part only, of a resin of the invention. Non-limiting examples of such articles are ophthalmic corrective lenses, solar lenses, glazings for vehicles or buildings. In these articles, the photochromic material of the invention may constitute the whole of the thickness of the article (mass article) or may only constitute a film or stratified layer applied on a support.

According to another of its objects, the invention also relates to a radically polymerisable composition, which is a precursor of a resin of the invention. Said composition comprises the monomers of formula [(I) and/or (II)+(III) and/or (IV)] and the effective amount of acidic or basic additive(s), in the sense of the invention. Said effective amount is, within this context, incorporated beforehand.

In the same manner, the composition in question can contain the effective amount of photochromic colorant(s). In any case, the composition contains it totally or partially, or not at all.

With reference to the acidic or basic additive(s), it may also be conceived that the polymerisable compositions, which are precursors of the resins of the invention, do not contain them (they are thus incorporated afterwards), or only contain a part of it. Said polymerisable compositions which contain at least one acidic additive or at least one basic additive, whatever the amount of their incorporation, also make up a part of the invention. In the end, the resins of the invention obviously contain an effective amount of it, which is effective with reference to the kinetics of return to fading.

Finally, according to a last object, the present invention relates to a method of preparing a photochromic resin, as described above.

Characteristically, said method comprises radically copolymerising (generally thermally, but other means, notably photochemically, are not at all excluded (see above)) of a mixture of suitable monomers, and incorporating (introducing), in one time, even in several times, beforehand and/or afterwards, together and/or separately, at least one photochromic colorant and at least one acidic or basic additive; said colorant(s) and additive(s) being finally incorporated in effective amounts.

The implementation variants of said method are thus multiple.

According to a preferred variant, said photochromic colorant(s) and acidic or basic additive(s) are introduced independently before the radical copolymerisation.

When they are introduced afterwards, they penetrate by diffusion within the resin (obtained by copolymerisation beforehand).

It is now proposed to illustrate the invention in a totally non-limiting manner by the Examples below.

The abbreviations used in said Examples are given in Table I below.

TABLE I

| Abbreviation | Material |
|---|---|
| Diacryl 121 or D121 | tetra-ethoxylated bisphenol A dimethacrylate |
| | (AKZO Chimie) |
| m-TMI | 3-isopropenyl-α,α-dimethylbenzylisocyanate |
| | (CYTEC) |
| m-PEG 350 | polyethylene glycol methyl ether of |
| | Mₙ = 350 (ALDRICH) |
| JEFFAMINE ED 900 | poly[propylene glycol - block - ethylene |
| | glycol - block - propylene glycol] |
| | bis-(2-aminopropylether) (HUNSTMAN) |
| TMI-m-PEG 350 | styrenic urethane monomer, synthesised in |
| | Example 1A |
| TMI-JEFFAMINE ED 900 | styrenic urea monomer, synthesised in |
| | Example 8A |
| DVB | divinylbenzene |
| BzMA | benzyl methacrylate |
| PETA | pentaerythritol triacrylate |
| STY | styrene |
| ADVN | 2-2′-azobis(2,4-dimethylpentanenitrile) |
| NDM | n-dodecane-1-thiol |
| CR49 | (2-(p-dimethylaminophenyl)-2- |
| | (p-methoxyphenyl)-5-methyl-7,9-dimethoxy- |
| | [2H]naphtho[1,2-b]pyran |
| | (described in FR-2,751,648) |
| DPP | diphenylphosphoric acid |
| DPPA | diphenylphosphinic acid |
| TPP | triphenylphosphine |
| MAA | methacrylic acid |
| MSA | 3-methylsalicylic acid |

### EXAMPLE 1

A. Synthesis of the Flexible, Monofunctional Styrenic Urethane Monomer (of Formula III)

140 parts by weight of polyethylene glycol monomethyl ether Mn=350 (m-PEG 350) and 0.06 g of tin dibutyldilaurate are charged into a glass recipient equipped with a stirrer and a nitrogen purge.

The mixture is heated at 50° C. with stirring and bubbling of nitrogen.

80.5 parts by weight of m-TMI are then added over about 1 hour.

After the addition of the m-TMI, the mixture is heated at 60° C. for 1 h to complete the reaction.

The urethane resin obtained (referenced TMI-m-PEG 350) is colourless and is free from residual isocyanate functions.

B. Preparation of the Improved Photochromic Resin:

20 parts by weight of the styrenic urethane monomer TMI-m-PEG350 (resin obtained above), 80 parts by weight of Diacryl 121 (monomer of formula I), 0.5 part by weight of NDM as chain transfer agent, 0.26 part by weight of ADVN as radical initiator, 0.05 part by weight of CR49 as photochromic colorant and 4 parts by weight of methacrylic acid (MAA) as acidic additive are mixed, until total dissolution of the compounds.

The mixture of monomers obtained is degassed and is poured into a mould comprising two parts between which are placed a plastified PVC gasket of 2 mm thickness, a clamp securing said two parts by squeezing said joint.

The polymerisation is then continued for 16 h at 53° C. and 2 h at 90° C.

After cooling to ambient temperature, the sample obtained is removed from the mould.

### EXAMPLE 2

The method of Example 1 was repeated, except that the 4 parts by weight of methacrylic acid (MAA) were replaced by 0.1 part by weight of diphenylphosphate (DPP) as acidic additive.

### EXAMPLE 3

The method of Example 1 was repeated, except that the 4 parts by weight of methacrylic acid (MAA) were replaced by 0.1 part by weight of diphenylphosphonic acid (DPPA).

### EXAMPLE 4

The method of Example 1 was repeated, except that 2 parts by weight of triphenylphosphine (TPP) were added instead of the 4 parts by weight of methacrylic acid (MMA).

### EXAMPLE 5

The method of Example 1 was repeated, except that 1 part by weight of 3-methylsalicylic acid (MSA) was added instead of the 4 parts by weight of methacrylic acid (MMA).

### EXAMPLE 6

29 parts by weight of the styrenic urethane monomer TMI-m-PEG 350 as synthesised in Example 1A were mixed with 44 parts by weight of Diacryl 121, 10 parts by weight of BzMA, 5 parts by weight of DVB, 5 parts by weight of PETA, 0.5 part by weight of NDM, 0.05 part by weight of CR49, 0.26 part by weight of ADVN and 4 parts by weight of MAA.

The resin composition obtained was polymerised in glass moulds as explained in Example 1B.

### EXAMPLE 7

The method of Example 6 was repeated, except that the 4 parts by weight of MAA were replaced by 0.1 part by weight of DPP.

### EXAMPLE 8

A. Synthesis of the Difunctional Styrenic Urea Monomer (of Formula IV):

360 parts by weight of JEFFAMINE ED 900 Mn=900 are charged into a glass recipient equipped with a stirrer, an addition funnel and a dry nitrogen purge.

The mixture is heated at 50° C. under bubbling of nitrogen until the starting material had completely melted.

161 parts by weight of m-TMI were then added over 1 h, by using the addition funnel.

The temperature of the mixture is maintained at 60° C. for 1 h in order to complete the reaction.

The urea monomer obtained (referenced TMI-JEFFAMINE ED 900) is a slightly viscous colourless liquid.

B. Preparation of the Improved Photochromic Resin:

The same method as in Example 6 was repeated in order to obtain the improved photochromic resin, except that the 29 parts by weight of TMI-m-PEG 350 were replaced by 29 parts by weight of TMI-JEFFAMINE ED 900.

### COMPARATIVE EXAMPLE 9

A photochromic resin was prepared as explained in Example 1B, except that 20 parts of styrene were used instead of the 20 parts of TMI-m-PEG350 and that the acidic additive was omitted.

The resin obtained was polymerised by the same method as that described in Example 1B.

### COMPARATIVE EXAMPLE 10

A photochromic resin composition was prepared as explained in Example 1B, except that 20 parts by weight of styrene were used instead of the parts by weight of TMI-m-PEG 350.

The resin obtained was hardened as described in Example 1B.

### COMPARATIVE EXAMPLE 11

The same method as in Comparative Example 9 was repeated, except that 0.1 part by weight of diphenylphosphate (DPP) was added as acidic additive.

### COMPARATIVE EXAMPLE 12

A photochromic resin was prepared and polymerised as described in Example 1B, except that the styrenic monomer TMI-m-PEG 350 and the acidic additive were omitted.

The composition of the resins, of each one of the Examples and comparative Examples above is summarised in Table II below.

TABLE II

| | Examples | | | | | | | | Comparative Examples | | | |
|---|---|---|---|---|---|---|---|---|---|---|---|---|
| Materials | 1 | 2 | 3 | 4 | 5 | 6 | 7 | 8 | 9 | 10 | 11 | 12 |
| D121 | 80 | 80 | 80 | 80 | 80 | 44 | 44 | 44 | 80 | 80 | 80 | 100 |
| TMI-m-PEG350 | 20 | 20 | 20 | 20 | 20 | 29 | 29 | 0 | 0 | 0 | 0 | 0 |
| TMI-JEFFAMINE | 0 | 0 | 0 | 0 | 0 | 0 | 0 | 29 | 0 | 0 | 0 | 0 |
| ED 900 | | | | | | | | | | | | |
| STY | 0 | 0 | 0 | 0 | 0 | 0 | 0 | 0 | 20 | 20 | 20 | 0 |
| DBV | 0 | 0 | 0 | 0 | 0 | 12 | 12 | 12 | 0 | 0 | 0 | 0 |
| BzMA | 0 | 0 | 0 | 0 | 0 | 10 | 10 | 10 | 0 | 0 | 0 | 0 |
| PETA | 0 | 0 | 0 | 0 | 0 | 5 | 5 | 5 | 0 | 0 | 0 | 0 |
| ADVN | 0.26 | 0.26 | 0.26 | 0.26 | 0.26 | 0.26 | 0.26 | 0.26 | 0.26 | 0.26 | 0.26 | 0.26 |
| NDM | 0.5 | 0.5 | 0.5 | 0.5 | 0.5 | 0.5 | 0.5 | 0.5 | 0.5 | 0.5 | 0.5 | 0.5 |
| CR49 | 0.05 | 0.05 | 0.05 | 0.05 | 0.05 | 0.05 | 0.05 | 0.05 | 0.05 | 0.05 | 0.05 | 0.05 |
| DPP | 0 | 0.1 | 0 | 0 | 0 | 0 | 0.1 | 0.1 | 0 | 0 | 0.1 | 0 |
| DPPA | 0 | 0 | 0.1 | 0 | 0 | 0 | 0 | 0 | 0 | 0 | 0 | 0 |
| TPP | 0 | 0 | 0 | 2 | 0 | 0 | 0 | 0 | 0 | 0 | 0 | 0 |
| MAA | 4 | 0 | 0 | 0 | 0 | 4 | 0 | 0 | 0 | 4 | 0 | 0 |
| MSA | 0 | 0 | 0 | 0 | 1 | 0 | 0 | 0 | 0 | 0 | 0 | 0 |

The optical quality was evaluated by visual inspection.

Lenses which were free from any defects were denoted <<+>>.

Lenses having some defects, such as flow lines or striations, were denoted <<−>>.

The photochromic performances were evaluated by submitting a 2 mm thick photochromic lens to a UV light (of a xenon arc lamp) at 25° C. until the coloration of the lens attained an equilibrium.

The fading kinetics are recorded by measuring the transmission at us time using a spectrophotometer HP 8452 from Hewlett Packard.

The percentage recovery was calculated as follows:

% recovery=(Tt−Td/Tb−Td)×100;

with Td which is the transmittance at 580 nm, at the equilibrium, of the material having darkened, Tt is the transmittance at 580 run, at a given time, and Tb which is the transmittance at 580 nm, of the non-coloured state.

The amount of fading is marked “+” if at least 50% recovery is observed after 10 min of fading.

The amount of fading is marked “−” if the percentage recovery is less than 50%after 10 min of fading.

The results of the tests aiming to test the photochromic properties and the optical quality are given in Table III below.

TABLE III

| | Amount of fading (%) and optical quality | | | | | | | | | | | |
|---|---|---|---|---|---|---|---|---|---|---|---|---|
| | | | | | | | | | Comparative | | | |
| | Examples | | | | | | | | Examples | | | |
| Time(s) | 1 | 2 | 3 | 4 | 5 | 6 | 7 | 8 | 9 | 10 | 11 | 12 |
| 0 | 0 | 0 | 0 | 0 | 0 | 0 | 0 | 0 | 0 | 0 | 0 | 0 |
| 1 | 1 | 1 | 1 | 1 | 2 | 2 | 2 | 2 | 0.2 | 0.2 | 0.1 | 5 |
| 2 | 2 | 2 | 2 | 3 | 5 | 3 | 4 | 4 | 0.6 | 0.5 | 0.1 | 1 |
| 4 | 4 | 5 | 6 | 6 | 9 | 6 | 7 | 8 | 1 | 1 | 0.5 | 3 |
| 8 | 8 | 10 | 11 | 12 | 17 | 12 | 15 | 16 | 2 | 3 | 1 | 6 |
| 100 | 50 | 66 | 67 | 73 | 84 | 66 | 87 | 88 | 14 | 15 | 14 | 48 |
| 200 | 63 | 81 | 82 | 84 | 94 | 76 | 92 | 92 | 17 | 19 | 18 | 54 |
| 400 | 75 | 88 | 89 | 91 | 98 | 85 | 94 | 94 | 25 | 26 | 26 | 59 |
| 600 | 80 | 90 | 91 | 92 | 98 | 89 | 94 | 95 | 29 | 30 | 31 | 63 |
| 800 | 85 | 92 | 94 | 94 | 99 | 92 | 95 | 96 | 31 | 32 | 33 | 66 |
| Amount | + | + | + | + | + | + | + | + | − | − | − | − |
| of | | | | | | | | | | | | |
| fading | | | | | | | | | | | | |
| Optical | + | + | + | + | + | + | + | + | + | + | + | − |
| quality | | | | | | | | | | | | |

What is claimed:

1. A photochromic resin obtainable by radical copolymerisation of a composition comprising:
at least one difunctional monomer selected from those of formula (I) and (II) below:
formula (I): 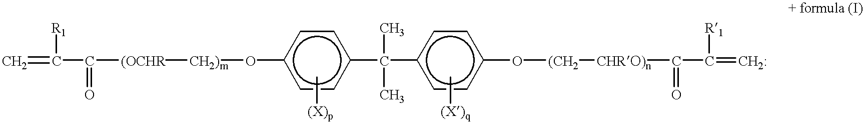
in which:
R₁, R′₁, R, and R′, which are identical or different, independently are a hydrogen or a methyl group;
m and n are, independently, integers between 0 and 4 inclusive;
X and X′, which are identical or different, are a halogen; and
p and q are, independently, integers between 0 and 4 inclusive;
formula (II): 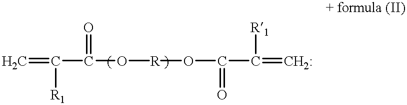
in which:
R₁ and R′₁, which are identical or different, independently are a hydrogen or a methyl group;
R is a linear or branched alkylene radical having 2 to 8 carbon atoms, a cycloalkylene radical having 3 to 6 carbon atoms, an ether radical of formula (R′—O—R″) in which R′ and R″, which are identical or different, independently are a linear or branched alkylene radical having 2 to 4 carbon atoms;
at least one other monomer, selected from the monofunctional monomers of formula (III) below and the alkenic difunctional monomers of formula (IV) below:
formula (III): 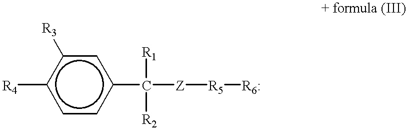
in which:
R₁ and R₂, which are identical or different, independently are hydrogen or an alkyl radical, which is linear or branched, having 1 to 4 carbon atoms;
R₃ and R₄, which are different, independently are one hydrogen and the other an alkenyl radical having 2 to 6 carbon atoms;
Z represents a carbamate function (—NH—CO—O—), a thiocarbamate function (—NH—CO—S—), a urea function (—NH—CO—NR₇, with R₇ representing hydrogen or a linear, branched, or cyclic alkyl group having 1 to 6 carbon atoms), or an oxazolidone function 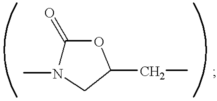
R₅ is selected from the group consisting of:
alkylene oxide radicals and polyalkylene oxide chains of formula: 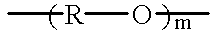
in which the R groups, which are identical or different when m≧2, are alkylene radicals which are linear or branched and which have 2 to 5 carbon atoms, and in which m is an integer, such that the total number of carbon atoms of said alkylene oxide radicals and polyalkylene oxide chains is between 2 and 112;
the ester radicals and the polyester chains of formula: 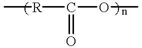
in which the R groups, which are identical or different when n≧2, are alkylene radicals which are linear or branched and which have 2 to 5 carbon atoms, and in which n is an integer such that the total number of carbon atoms of said ester radicals and polyester chains is between 2 and 168;
the siloxane radicals and the polysiloxane chains of formula: 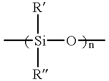
in which the R′ and R″ groups, which are identical or different when n≧2, are, independently, alkyl radicals having 1 or 2 carbon atoms, and in which n is an integer between 1 and 18;
the carbonate radicals and the polycarbonate chains of formula: 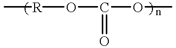
in which the R groups, which are identical or different when n>2, are alkylene radicals which are linear or branched and which have 1 to 5 carbon atoms, and in which n is an integer between 1 and 21;
R₆ is an alkyl radical or an aryl radical;
formula (IV): 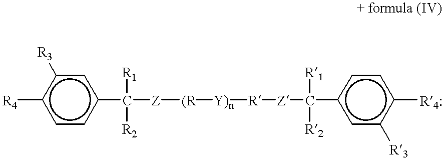
in which:
R₁, R′₁, R₂, and R′₂, which are identical or different, independently are hydrogen or an alkyl radical which is linear or branched and which has 1 to 4 carbon atoms;
R₃ and R₄, which are different, independently are one hydrogen and the other an alkenyl radical having 2 to 6 carbon atoms;
R′₃ and R′₄, which are different, independently are one hydrogen and the other an alkenyl radical having 2 to 6 carbon atoms;
Z represents a carbamate function (—NH—CO—O—), a thiocarbamate function (—NH—CO—S—), a urea function (—NH—CO—NH—), or an oxazolidone function 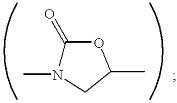
Z′, independently of Z, represents a carbamate function (—O—CO—NH—), a thiocarbamate function (—S—CO—NH—), a urea function (—NH—CO—NH—), or an oxazolidone function 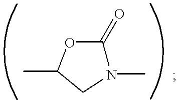
R′ represents a linear or branched alkylene radical having 2 to 4 carbon atoms;
R, which is identical or different when n≧2, is a linear or branched alkylene radical having 2 to 4 carbon atoms;
Y, which is identical or different when n≧2, is oxygen or sulphur;
n is an integer defined such that the total number of carbon atoms contained in the long chain situated between the two Z and Z′ units is equal to at least 18;
wherein said resin comprises:
an effective amount of at least one photochromic colorant;
at least one acidic additive or of at least one basic additive in an amount which is effective for improving the kinetics of return to the light state of said resin, wherein said amount of said at least one acidic additive or of said at least one basic additive represents at the most 5%, of the weight of the polymerisable monomers of the composition.

2. A resin according to claim 1, wherein m and n in formula (I) are independently equal to 1 or 2.

3. A resin according to claim 1, wherein X and X′ in formula (I), which are identical or different, represent a chlorine and/or a bromine.

4. A resin according to claim 1, wherein each of R₁ and R₂ in formula (III) is a methyl group.

5. A resin according to claim 1, wherein each of R₃ and R₄ in formula (III) is an isopropenyl radical.

6. A resin according to claim 1, wherein each of R₁, R′₁, R₂, and R′₂ in formula (IV) is a methyl group.

7. A resin according to claim 1, wherein each of R₃, R₄, R′₃, and R′₄ in formula (IV) is an isopropenyl radical.

8. A resin according to claim 1, wherein, in formula (IV), R₃=R′₃ and R₄=R′₄.

9. A resin according to claim 1, wherein n is an integer defined such that the total number of carbon atoms contained in the long chain situated between the two Z and Z′ units is between 18 and 112 inclusive.

10. A resin according to claim 1, wherein said amount of said at least one acidic additive or of said at least one basic additive represents between 0.01 and 3% of the weight of the polymerisable monomers of the composition.

11. A resin according to claim 1, wherein said composition comprises at least one monomer of formula (I).

12. A resin according to claim 11, wherein said composition comprises at least one monomer of formula (III) in which R₃ is an isopropenyl radical and in which R₅ represents an alkylene oxide radical or polyalkylene oxide of formula:

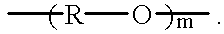

13. A resin according to claim 11, wherein said composition comprises at least one monomer of formula (IV) in which R₃ and R′₃ are isopropenyl radicals, Y=O, and Z and Z′ are urea functions.

14. A resin according to claim 1, wherein said composition comprises at least one monomer of formula (III) in which R₃ is an isopropenyl radical and in which R₅ represents an alkylene oxide radical or polyalkylene oxide of formula:

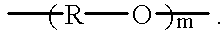

15. A resin according to claim 1, wherein said composition comprises at least one monomer of formula (IV) in which R₃ and R′₃ are isopropenyl radicals, Y=O, and Z and Z′ are urea functions.

16. A resin according to claim 1, wherein said composition further comprises:
at least one aromatic monovinylic monomer of formula (C): 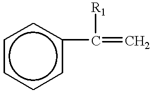
in which R₁=H or CH₃;
and/or
at least one aromatic divinylic monomer of formula (D): 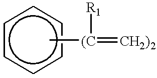
in which R₁=H or CH₃;
and/or
at least one (meth)acrylic monomer of formula (E):
CH₂═C(R)—COOR′
in which R=H or CH₃ and in which R′ is a linear or branched alkyl radical having 1 to 16 carbon atoms, an optionally substituted benzyl or phenoxy(C₁-C₄)alkyl radical, or a polyoxyethylene group of formula —(CH₂—CH₂—O)ₙR″ in which n is an integer between 1 and 10 and R′=CH₃ or C₂H₅;
and/or
diallylphthalate;
and/or
at least one acrylic monomer having at least three reactive functions.

17. A resin according to claim 16, wherein said at least one acrylic monomer having at least three reactive functions is selected from the group consisting of pentaerythritol triacrylate, pentaerythritol tetraacrylate, propoxylated glycerol triacrylate, trimethylolpropane triacrylate, polyurethane triacrylate, and dipentaerythritol hexaacrylate.

18. A resin according to claim 16, wherein said at least one acrylic monomer having at least three reactive functions is pentaerythritol triacrylate.

19. A resin according to claim 1, wherein said photochromic colorant(s) is(are) selected from chromenes.

20. A resin according to claim 1, wherein said resin comprises at least one acidic additive selected from the group consisting of copolymerisable acids and non-copolymerisable acids.

21. A resin according to claim 20, wherein said at least one acidic additive has a dissociation constant k>10⁻⁶.

22. A resin according to claim 20, wherein said at least one acidic additive is selected from the group consisting of:
organic sulphonic acids;
organic phosphorus-containing acid compounds; and
carboxylic acids.

23. A resin according to claim 22, wherein said at least one acidic additive is a sulphonic acid.

24. A resin according to claim 23, wherein said sulphonic acid is selected from the group consisting of para-toluenesulphonic acid, naphthalenesulphonic acids, sulphosalicylic acids, hydroxybenzene-sulphonic acids, and dodecylbenzenesulphonic acids.

25. A resin according to claim 22, wherein said at least one acidic additive is a phosphorus-containing compound.

26. A resin according to claim 25, wherein said phosphorus-containing compound is selected from the group consisting of diphenylphosphoric acid, diphenylphosphinic acid, bis(p-methoxy-phenyl)phosphinic acid, alkylphosphoric acids, and alkylphosphonic acids.

27. A resin according to claim 22, wherein said at least one acidic additive is an aliphatic carboxylic acid.

28. A resin according to claim 27, wherein said aliphatic carboxylic acid is selected from the group consisting of formic, acetic, propionic, butyric, isobutyric, chloroacetic, glycolic, cyclohexane-carboxylic, oxalic, malonic, succinic, fumaric, maleic, malic, acrylic, methacrylic, crotonic, propiolic, itaconic, and aconitic acids and mono-2-(methacryloxy)ethyl succinate.

29. A resin according to claim 27, wherein said aliphatic carboxylic acid is selected from the group consisting of acrylic, methacrylic, and maleic acids.

30. A resin according to claim 22, wherein said at least one acidic additive is an aromatic carboxylic acid.

31. A resin according to claim 30, wherein said aromatic carboxylic acid is selected from the group consisting of benzoic acid, o-, m-, or p-toluic acids, naphthoic acids, salicylic acids, phenylacetic, mandelic acids, chloro- and/or nitrobenzoic acids, veratric, o-phthalic, o-phenyldiacetic, tricarballylic acids, and mono-2-(methacryloxy)ethyl phthalate.

32. A resin according to claim 30, wherein said aromatic carboxylic acid is selected from the group consisting of 3-methylsalicylic acid and 4-methylsalicylic acid.

33. A resin according to claim 1, wherein said resin comprises at least one basic additive selected from the group consisting of copolymerisable bases and non-copolymerisable bases.

34. A resin according to claim 33, wherein said at least one basic additive is an acrylate or methacrylate monomer bearing at least one tertiary amine function.

35. A resin according to claim 34, wherein said acrylate or methacrylate monomer bearing at least one tertiary amine function is selected from the group consisting of dimethylaminoethyl methacrylate and diethylaminoethyl methacrylate.

36. A resin according to claim 33, wherein said at least one basic additive is a triarylphosphine.

37. A resin according to claim 36, wherein said triarylphosphine is triphenylphosphine.

38. An article comprising a resin according to claim 1.

39. An article according to claim 38, wherein said article is an ophthalmic article.

40. An article comprising a resin according to claim 11.

41. An article according to claim 40, wherein said article is an ophthalmic article.

42. An article comprising a resin according to claim 20.

43. An article according to claim 42, wherein said article is an ophthalmic article.

44. An article comprising a resin according to claim 22.

45. An article according to claim 44, wherein said article is an ophthalmic article.

46. An article comprising a resin according to claim 33.

47. An article according to claim 46, wherein said article is an ophthalmic article.

48. A radically polymerisable composition comprising:
at least one difunctional monomer selected from those of formula (I) and formula (II), as defined in claim 1;
at least one other monomer, selected from the monofunctional monomers of formula (III) and the alkenic difunctional monomers of formula (IV), formulae (III) and (IV) being as defined in claim 1; and
at least one acidic additive or at least one basic additive.

49. A radically polymerisable composition according to claim 48, wherein said at least one acidic additive or at least one basic additive is present in an amount effective for improving the kinetics of return to the light state of a photochromic resin obtained from said polymerisable composition, wherein said amount of said at least one acidic additive or of said at least one basic additive represents at the most 5% of the weight of the polymerisable monomers which are present in said composition.

50. A radically polymerisable composition according to claim 49, wherein said amount of said at least one acidic additive or of said at least one basic additive represents between 0.01 and 3% of the weight of the polymerisable monomers which are present in said composition.

51. A method of preparing a photochromic resin, said method comprising:
radically copolymerising a composition comprising at least one difunctional monomer selected from those of formulae (I) and (II), as defined in claim 1, and at least one other monomer selected from the monofunctional monomers of formula (III) and the alkenic difunctional monomers of formula (IV), formulae (III) and (IV) being as defined in claim 1;
introducing, before said copolymerisation, into the composition to be copolymerised and/or, after said copolymerisation, into the copolymerised composition, at least one photochromic colorant and at least one acidic or basic additive, said colorant(s) and additive(s) intervening, together or separately, in an amount effective to confer photochromic properties to the resin and to improve the kinetics of return to the light state of said resin, respectively.
